(19) United States
(12) Patent Application Publication
(10) Pub. No.: US 2016/0243991 A1
(43) Pub. Date: Aug. 25, 2016

(54) Support Platform for a Truck

(71) Applicant: JOHN WIESNER INC., Conroe, TX (US)

(72) Inventor: David A. Rodgers, Conroe, TX (US)

(73) Assignee: JOHN WIESNER INC., Conroe, TX (US)

(21) Appl. No.: 14/627,032

(22) Filed: Feb. 20, 2015

(51) Int. Cl. B60R 3/00; B62D 49/00

(52) U.S. Cl. CPC B60R 3/005; B60R 3/00; B62D 49/005

(57) ABSTRACT

A support platform for a truck of the type utilized for pulling a semi-trailer includes at least one horizontal support surface and at least one step depending from the horizontal surface. The platform allows a truck driver to safety access truck accessories that are typically mounted on the back side of the truck cab. A taillight assembly may optionally be attached to a rear portion of the support platform.

### BACKGROUND OF INVENTION

1. Field of the Invention

This application is directed to a support platform which is designed to be attached to the truck cab portion of a semi-trailer truck. The platform extends over the open wheels of the truck and includes a downwardly extending step portion to permit access to the platform.

2. Description of Related Art

Currently the open wheels of the truck cab portion of a semi-trailer truck are either uncovered or covered by arcuate fenders. Items such as chains and strapping devices are attached to the exterior rear wall of the truck cab. Drivers struggle to find sound footing while attempting to store or retrieve items on the cab wall.

### BRIEF SUMMARY OF THE INVENTION

The current invention overcomes the problems associated with the prior art by providing a generally horizontal platform for stability and a step portion to enable the driver of a semi-trailer truck to access the area behind the cab portion of the truck. The platform may extend on one or both sides of the truck and may cover the front or both the front and rear wheel sets of the truck.

### BRIEF DESCRIPTION OF THE SEVERAL VIEWS OF THE DRAWING(S)

FIG. 1 is a perspective view of a truck outfitted with a support platform according to an embodiment of the invention.

FIG. 2 is a side view of the truck and platform shown in FIG. 1.

FIG. 3 is a perspective view of a truck outfitted according to a second embodiment of the invention.

FIG. 4 is a side view of the truck and platform shown in FIG. 3.

FIG. 5 is a side view of a truck and platform according to another embodiment of the invention.

FIG. 6 is a top view of the support platform shown in FIG. 6.

FIG. 7 is a cross-sectional view taken along line 7-7 of FIG. 6.

FIG. 8 illustrates a particular arrangement for securing the support platform to the truck.

### DETAILED DESCRIPTION OF THE INVENTION

Referring to FIG. 1, an embodiment of the invention is shown outfitted to a truck 10 that is the driving vehicle for a semi-trailer truck for example a semi-trailer truck commonly referred to as an eighteen wheeler.

Truck 10 includes a cab portion 11 and a rack 12 supported on the truck. Rack 12 may serve as a support for items such as chains 13 and ratchets 14 and a tool box 15 which are often used as accessories for the semi-trailer.

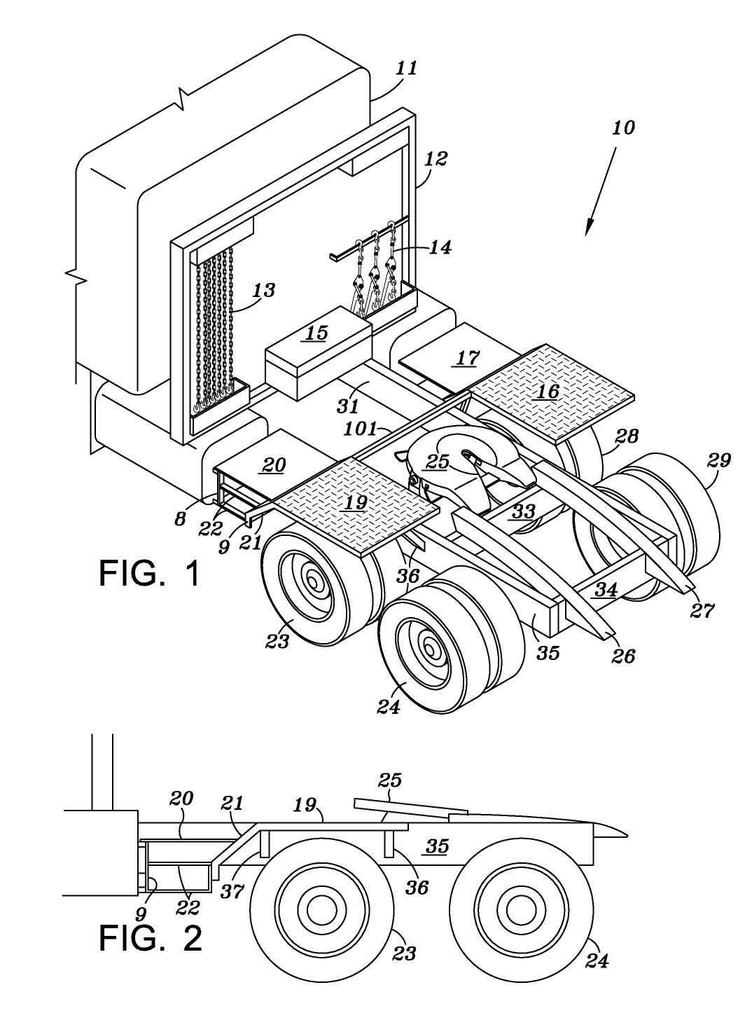

A support platform as shown in FIG. 1 include a first generally horizontal plate member 19, an inclined plate portion 21 and a second generally horizontal plate portion 20. One or more steps 22 extend between supports 9 and 8 as shown in FIG. 2. The support platform may be attached to a frame member 35 of the truck by suitable braces 36 and 37 shown in FIGS. 1 and 2. Thus the support platform is supported in a cantilever fashion from the truck frame. Other methods of securing the support platform to the truck may be employed. For example, apertures may be provided in the frame beams 35 and 31 which may be utilized for bolting the support platform to the truck.

A similar platform including plates 17, 18 and 16 may be provided on the right side of the truck as shown in FIG. 1. Plates 19 and 16 are sized so as to cover the widths of wheel pairs 23 and 28. They also are of a length to cover the diameters of the wheels as shown in FIG. 2. A support bar 101 is positioned between and welded to plates 16 and 19. Brackets similar to 36 may extend from frame members 31 and 35 to further support bar 101.

Truck 10 also includes a fifth wheel 25 with ramps 26 and 27 leading to it and cross frame members 33 and 34. Third and fourth wheel pairs 24 and 29 may also be provided.

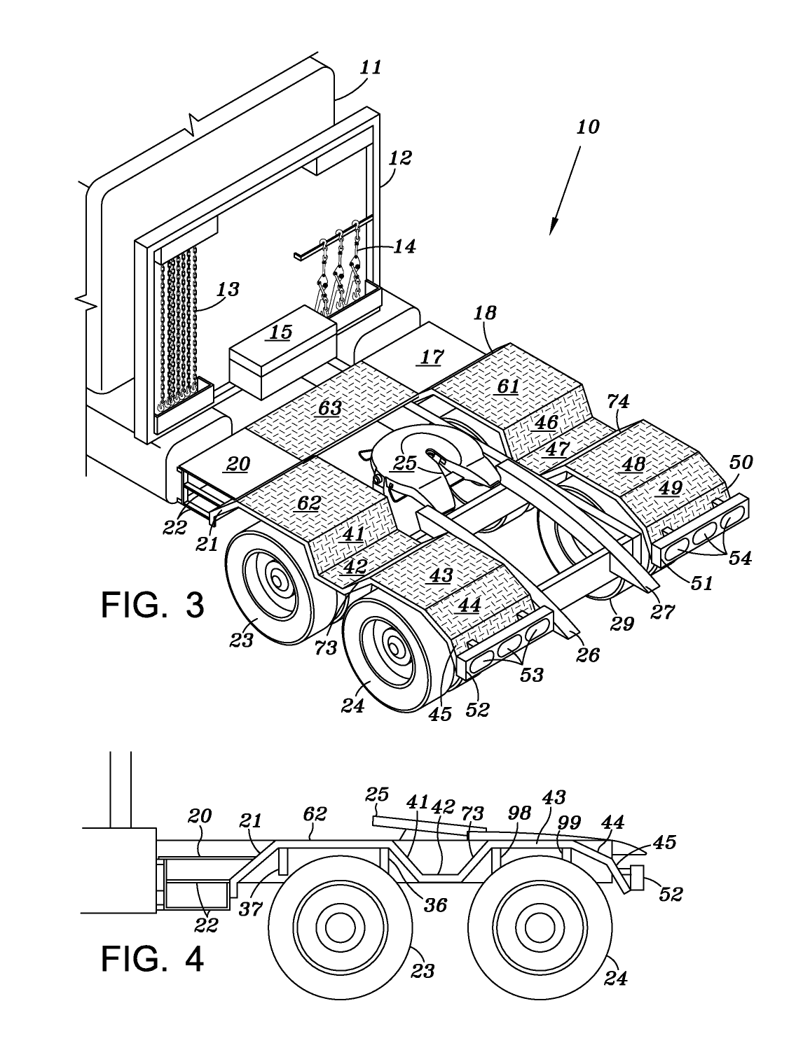

A second embodiment of a support platform according to the invention is shown in FIGS. 3 and 4. This embodiment is similar to that shown in FIGS. 1 and 2, however, in addition to plates 20, 21 and 19, the support platform also includes an included portion 41, a horizontal portion 42 that extends between wheel pairs 23 and 24, an inclined portion 73 and a third horizontal plate 43 that extends above wheel pair 24 and two downwardly extending inclined portions 44 and 45. As shown in FIG. 4, portion 45 extends rearwardly of wheel pair 24.

As in the embodiment of FIGS. 1 and 2, a second support platform includes plates 61, 46, 47, 74, 48, 49 and 50 may extend on the right side of the truck. Each support platform may be supported in a cantilever fashion by support brackets 37, 38, 98 and 99 as shown in FIG. 4. Tail light housings 52 and 51 may be attached to plate members 45 and 50 as shown in FIG. 4. Tail light assemblies 53 and 54 are mounted within the tail light housings. A central plate 63 may be positioned between plate members 17 and 20 as shown in FIG. 3. Plate 63 can be mounted to the truck in any suitable fashion. A support bar similar to 101 may also extend between plates 62 and 61. Brackets may be used for further support. They may extend between the plates 62 and 61 and frame members 26 and 27.

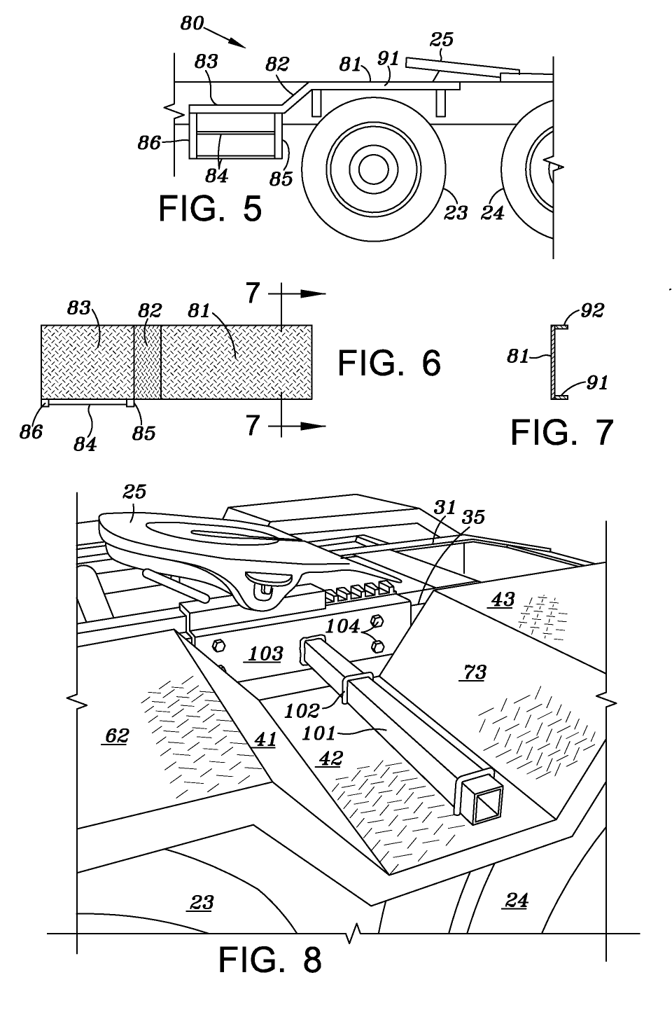

FIGS. 5-7 illustrate a further embodiment of the invention. In this embodiment the support platform 80 includes horizontal plates 83 and 81 connected by an inclined plate 82. A pair of stairs 84 are supported below and to the side of plate 83 by vertical bars 85 and 86 attached to plate 83. Plates 81, 82 and 83 as well as the plates illustrated in FIGS. 1-4 may be formed of diamond cut sheet metal of a suitable thickness, between ⅛″ to ½″ for example. The metal may be steel or aluminum or any suitable strength metal alloy.

As shown in FIG. 7 horizontal plate 81 as well as any of the plates shown in the various embodiments may include a top plate 81 and depending frame members 91 and 92 which act as a splash guard for the wheels of the truck in rainy conditions.

A mounting arrangement for the support platform is shown in FIG. 8. Fifth wheel 25 is supported by a support frame 103 which is secured to both sides of the truck frame 31 and 35 by a plurality of bolts 104. A rod member 101 is fixed to the fifth wheel support frame by welding for example. A pair of U bolts 102 extending through plate 42 and are secured to the underside of plate 42 by nuts. Thus rod member 101 provides additional support for the support platform. Additionally, depending upon the length of support from 103, braces 37 and 36 and braces 98 and 99 can also be welded to the support frame 103.

Although the present invention has been described with respect to specific details, it is not intended that such details should be regarded as limitations on the scope of the invention, except to the extent that they are included in the accompanying claims.

1. A support platform for a truck of the type having a cab and a fifth wheel, the truck having at least two axles comprising:
a first generally horizontal plate member adapted to be positioned above a pair of wheels on a first axle of the truck,
a second generally horizontal plate member connected to the first generally horizontal plate member by an inclined member such that the second plate member is positioned below the first plate member when the support platform is secured to the truck; and
at least one step extending downwardly from the second generally horizontal plate member.

2. A support platform as claimed in claim 1 including a third generally horizontal plate member connected to the first generally horizontal plate member and adapted to be positioned above a second pair of wheels on a second axle of the truck.

3. A support platform as claimed in claim 2 further including a second and a third oppositely inclined plate members extending between the first and third generally horizontal plat members.

4. A support platform as claimed in claim 3 further including a fourth generally horizontal plate member positioned between the second and third inclined members, thereby forming a gap allowing access to a control mechanism for the fifth wheel.

5. A support platform as claimed in claim 4 further including a rod extending along a top surface of the fourth generally horizontal plate member and secured to it.

6. A support platform as claimed in claim 4 further including a fourth inclined plate extending rearwardly of the third generally horizontal plate and a light housing including a light assembly secured to the fourth inclined plate.

7. A support platform as claimed in claim 1 further including a pair of support brackets attached to the support platform for securing the support platform to the truck.

8. A support platform as claimed in claim 1 further including a pair of frame members extending downwardly from the side edges of the first generally horizontal plate member thereby confining a portion of water spray formed by the rotation of the truck wheels and tires.
